(19) United States
(12) Patent Application Publication
(10) Pub. No.: US 2021/0407722 A1
(43) Pub. Date: Dec. 30, 2021

(54) MAGNETIC SHELL AND MAGNETIC DEVICE

(71) Applicant: Schaffner EMV AG, Luterbach (CH)

(72) Inventor: Roberto MRAD, Zuchwil (CH)

(21) Appl. No.: 17/355,508

(22) Filed: Jun. 23, 2021

(30) Foreign Application Priority Data
Jun. 30, 2020 (EP) 20183062.7

(51) Int. Cl. H01F 21/06; H01F 21/04

(52) U.S. Cl. CPC H01F 21/06; H01F 21/04

(57) ABSTRACT

A magnetic shell for a magnetic device juxtaposable to another shell form a magnetic core, wherein at least part of the surfaces of the magnetic shells meet when the shells are juxtaposed and form at least an air gap, wherein the magnetic core expands and contracts under temperature changes along a main expansion direction at the air gap, characterized in that the surfaces of the magnetic shells that meet to form the air gap are at least in part disposed parallel to the main expansion direction at the air gap.

### TECHNICAL DOMAIN

The present invention relates to a magnetic device with a high-permeability core having an air gap, that exhibits a low sensitivity to temperature changes.

### RELATED ART

Magnetic inductive component such as inductances, transformers, ad chokes often include, in their magnetic circuit, an air gap, in order to soften the saturation of the inductive components, achieve a desired magnetic reluctance or, in the case of inductances, increase the magnetic energy that can be stored in the component. A common shortcoming of such devices, however, is that the inductance of the component is very sensitive to the thickness of the air gap and even tiny deviations from the nominal values will translate in considerable changes in the inductance. To obviate his, it is known to include precise spacers and shims to control and keep constant the width of the air gap, but these measures cannot prevent ail changes, especially those of thermal origin.

Another device used in the art to limit this undesirable effect is the potting of the device in a compound or a glue having a low coefficient of thermal expansion, or CTE. This is not a completely satisfactory solution, however, and is not cost-effective.

Many applications, including those in the automotive sector require operation in an extended temperature range and with severe vibrations, together with a severe control of the tolerances and low thermal drifts. Magnetic devices with a lower sensitivity to temperature changes and mechanical influences that may alter the width of the air gaps are therefore highly desirable.

### SHORT DISCLOSURE OF THE INVENTION

An aim of the present invention is the provision of a magnetic component that overcomes the shortcomings and limitations of the state of the art.

According to the invention, these aims are attained by the object of the attached claims, and especially by a magnetic shell for a magnetic device juxtaposable to another shell form a magnetic core, wherein at least part of the surfaces of the magnetic shells meet when the shells are juxtaposed and form at least an air gap, wherein the magnetic core expands and contracts under temperature changes along a main expansion direction at the air gap, characterized in that the surfaces of the magnetic shells that meet to form the air gap are at least in part disposed parallel to the main expansion direction at the air gap.

The invention relates also to a magnetic device comprising at least two magnetic shells as defined above juxtaposed and forming a magnetic core, and at least one electric winding for generating a magnetic flux in the magnetic core.

Dependent claims relate to important and potentially useful features of the invention that are not however essential, and include special shapes of the shell, that can be “E”-shaped to give a three-legged core, “C”-shaped, pot shaped, or have any suitable shape; stepped surfaces at the air gaps; and configuring the cores such that, when they are juxtaposed, the air gap can be zero width or another value of width defined by design where the surfaces are parallel to the main expansion direction.

With respect to what is known in the art, the magnetic cores assembled from the shell of the invention exhibit a magnetic reluctance that is less temperature-dependent than many cores of the prior art. They can be assembled in any suitable way, including by potting, but their favourable thermal properties do not depend on the use of special CTE compounds or adhesive. In the inductors and magnetic devices of the invention the series resistance introduced by fringe fields at the airgap may be lower than in similar devices known in the art.

### SHORT DESCRIPTION OF THE DRAWINGS

Exemplar embodiments of the invention are disclosed in the description and illustrated by the drawings in which:

FIGS. 1a and 1b illustrate schematically a first example of the invention,

FIG. 1c shows a variant of the example of FIG. 1

FIGS. 2a and 2b illustrate another example of the invention,

FIG. 3 is a plot of temperature-induced changes of impedance

### EXAMPLES OF EMBODIMENTS OF THE PRESENT INVENTION

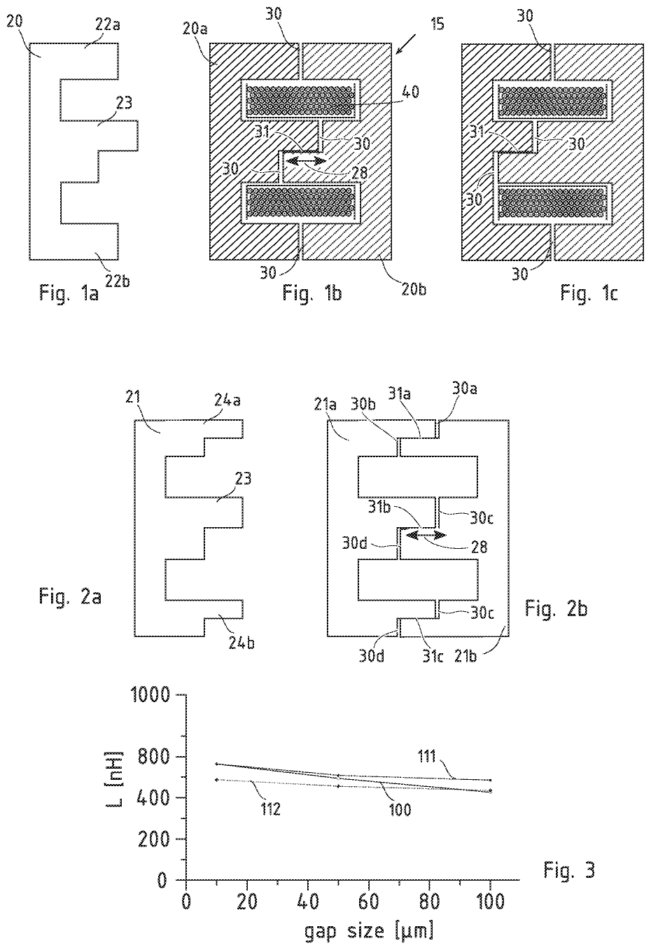

FIG. 1a shows a shell 20 that can be juxtaposed to another shell of identical or compatible shape to make a magnetic core. The shell 20 can be made of any suitable magnetic material, including powder magnetic and laminated magnetic materials. A non-exhaustive list of possible materials includes Nickel-Zink ferrites, Manganese-Zink ferrites, other ferrites, Si—Fe electrical steel, sendust, iron powders, permalloy and many other. The example shown in the figures is a “E”-shaped shell, that can be joined to another shell of the same configuration to obtain a three-legs magnetic core, but the invention is not limited to these shapes and could be applied to any of the standard core shapes such as “ER”, “EQ”, “EP”, “C”, pot, etc., as well as to many custom shapes.

FIG. 1b shows a magnetic device 15—an inductor in this case—comprising a winding 40 on the centre leg of a three-legs core formed by two juxtaposed “E” shells 20. In the drawings, the shells are identical, which may be desirable as reducing the bill of materials but is not an essential feature of the invention. The shells 20a, 20b could also be different and configured for providing the desired core shape when joined. The legs may be cylindrical, square, or have any suitable shape and need not be flat as in the examples. The at least two shells can have any suitable shape. The manner of assembling together the shells is also amenable to several variations, without leaving the scope of the invention. The shells may be prismatic and assembled “LEGO-style”, with one shell or leg fitting into a corresponding shape of the opposite shell, such as a cylindrical centre lef filling into a hollow cylindrical opposite leg in the other shell. Lef and right shell can be symmetric or different.

The juxtaposing of the shells forms a magnetic core with air gaps 30, 31 where the surfaces of the shells 20a, 20b come near. The width of the air gap can be determined by shims, separators, interposition of potting compound, or any other means. Importantly, the air gaps of the centre leg 30, 30 are oriented along two orthogonal direction. Part of the gap arises from the juxtaposing of surfaces 30 that are orthogonal to the axis of the leg—and to the general direction of the magnetic flux. Part of the air gap arises from the meeting of surfaces 31 that are aligned with the axis of the leg. This variety of directions arises from the special configuration of the centre leg 23 that is stepped. Side legs 22a and 22b have a butt end, in this variant. The axial air gaps 30 need not have the same width as the transversal air gap 31 and in fact, in the presented example, the transversal air gap 31 is considerably narrower and could reduce to zero, with the surfaces 30 in contact, in some realizations.

The invention is not limited to stepped legs with surfaces parallel and orthogonal to the leg axis and could include, in non-represented variants, legs with slanted or curved meeting surfaces.

When the temperature of the core changes, its material will expand and contract according to the temperature variations. The width of the air gap in the centre leg will change accordingly, and so will the reluctance of the magnetic core and the impedance of the coil 40. Thermal expansion will tend to move the shells 20a, 21a apart from one another, as indicated by the double arrow 28, especially if the assembly includes organic material such as adhesives, separators, or potting compound, which have a high coefficient of thermal expansion. The arrow 20 indicates the main expansion direction at the air gap, determined by the coefficients of thermal expansion of all the materials involved, including separators and adhesives.

Thermal expansion has opposite effects on the axial air gaps 30, that increase in width, and on the transversal air gap 31, whose width is essentially unchanged, while the transverse area of gap 31 is very slightly reduced. Thanks to these features, the reluctance of the core and the impedance of the coil 40 change less than in a standard E core where the centre leg and the side leg end with a flat transversal surface (vertical in the figures).

Note that the magnetic device can be an inductor, a choke, a transformer, or any other device. The final assembly will include at least one winding r coil, that can be made of enamel wire, litz wire, or any other type of conductor, including PCB tracks and rigid bars. The coil or coils can be wound around the centre leg, the side legs, or the top and bottom yokes, and can be split on different legs and parts of the magnetic circuit.

The air gap generates an amount of fringe field that radiates around the gap itself. This contributes to the increase of coil resistance at high frequency, due to local eddy currents in the conductors. In the invention, the fringe fields are at least in part rotated by 90 degrees and have a lesser impact on the high frequency resistance of the coil, because they are oriented parallel to the current direction.

FIG. 1c illustrates a variant of the invention in which the stepped air gap 30, 31 is not in the middle of a leg but aligned with a back wall of a core. In non-illustrated variants, the gaps could be in any intermediate position as well.

FIGS. 2a and 2b show another variant of the invention with stepped gaps not only on the centre leg, but also on the side legs. This core will be even more immune to thermal variations. The stepped gaps may be in the middle of the legs as drawn, or in any other position.

FIG. 3 plots the inductance of a coil wound around a core as that of FIG. 1b (plot 111), a core as that of FIG. 2b (plot 112), or a core of known type with straight air gaps (plot 100) for different gap sizes. The gap size is directly determined by the temperature and may be for example 10 μm, at ambient temperature, 50 μm at 100° C., and 150 μm at 150° C. The conventional design (plot 100) exhibits an inductance drop of about 100 nH, while the variants of FIGS. 1b and 2b show drops of 75 nH, respectively 66 nH, proving the advantages of the invention.

### REFERENCE SYMBOLS IN THE FIGURES

15 magnetic device
20 “E” shell with stepped centre leg
20a first shell
20b second shell
21 “E” shell with stepped legs
21a first shell
21b second shell
22a side straight leg
22b side straight leg
23 centre stepped leg
24a side stepped leg
24b side stepped leg
28 main direction of thermal expansion
30 axial air gap, centre leg
30a component of axial air gap, first side leg
30b component of axial air gap, first side leg
30c component of axial air gap, second side leg
30d component of axial air gap, second side leg
31 transverse air gap, centre leg
31a transverse air gap, first side leg
31b transverse air gap, centre leg
31c transverse air gap, first side leg
40 coil, winding
100 impedance of a conventional device
111 impedance of a first variant of the invention
112 impedance of a second variant of the invention

1. A magnetic shell for a magnetic device juxtaposable to another shell form a magnetic core, wherein at least part of the surfaces of the magnetic shells meet when the shells are juxtaposed and form at least an air gap, wherein the magnetic core expands and contracts under temperature changes along a main expansion direction at the air gap, characterized in that the surfaces of the magnetic shells that meet to form the air gap are at least in part disposed parallel to the main expansion direction at the air gap.

2. The magnetic shell of claim 1, wherein the shells have “E” shape and are juxtaposable to another similar shell to give a 3-legs core with one or three air gaps.

3. The magnetic shell of claim 1, wherein the shells have “C” shape.

4. The magnetic shell of claim 1, wherein the surfaces that meet to form the air gap are stepped.

5. The magnetic shell of claim 1, wherein the air gap between the surfaces parallel to the main expansion direction is essentially zero.

6. A magnetic device comprising at least two magnetic shells according to claim 1 juxtaposed and forming a magnetic core, and at least one electric winding for generating a magnetic flux in the magnetic core.
